(19) United States
(12) Patent Application Publication
(10) Pub. No.: US 2010/0324225 A1
(43) Pub. Date: Dec. 23, 2010

(54) Controlled-Rheology Polypropylene

(76) Inventor: Michael Zummallen, Sugar Land, TX (US)

Correspondence Address: WHYTE HIRSCHBOECK DUDEK S.C./DOW;Intellectual Property Department, 555 East Wells Street, Suite 1900, Milwaukee, WI, 53202, US

(21) Appl. No.: 12/819,677

(22) Filed: Jun. 21, 2010

Related U.S. Application Data
(60) Provisional application No. 61/219,559, filed on Jun. 23, 2009.

(51) Int. Cl. C08F 8/00

(52) U.S. Cl. 525/333.8

(57) ABSTRACT

Controlled rheology (CR) polypropylene resins are prepared by a process comprising the step of contacting under scission conditions a non-CR-polypropylene resin having a low melt flow rate (MFR) with cyclic peroxide. The CR polypropylene resins made by the process of this invention are useful in manufacturing articles that exhibit reduced VOC emissions relative to CR-polypropylene resins made by an identical process except with non-cyclic peroxide. These low-VOC, CR-polypropylene resins are particularly useful in making non-metallic components for automobile interiors.

### CROSS REFERENCE TO RELATED APPLICATION

This application claims the benefit of U.S. Provisional Application No. 61/219,559 filed Jun. 23, 2009.

### FIELD OF THE INVENTION

This invention relates to polypropylene. In one aspect, the invention relates to controlled rheology (CR) polypropylene while in another aspect, the invention relates to a method of making a controlled rheology polypropylene using cyclic peroxide. In still another aspect, the invention relates to an article of manufacture made from a CR polypropylene made with cyclic peroxide.

### BACKGROUND OF THE INVENTION

When organic peroxides are mixed with polypropylene in the melt phase, the polymer experiences scission, i.e., its molecular weight is reduced. The resulting polypropylene also has a narrower molecular weight distribution than the starting material, and it exhibits improved flowability during the fabrication of finished plastic products.

Commercial polypropylenes that are produced in the presence of organic peroxides are known as controlled rheology (CR) resins. Although a wide variety of peroxides are available, 2,5-dimethyl-2,5-bis(t-butylperoxy)hexane, a linear aliphatic diperoxide, is the peroxide of choice. This peroxide is commercially available as LUPERSOL 101 from the Lucidol division of Pennwalt Corporation, and as TRIGONOX 101 from Akzo Nobel.

Although CR-resins made with a linear aliphatic diperoxide exhibit good processability, the resins contain and produce excessive quantities of volatile organic compounds (VOC), especially for certain end uses such as for the manufacture of articles or component parts for the automotive industry.

The peroxide compound is typically mixed with the polypropylene (which is usually in a particulate form such as pellets, powder or flake) prior to their combined introduction to an extruder, sometimes under an inert gas, to melt them by heat and/or the mechanical energy of the screw or mixing blades. The melt is then extruded as pellets, ribbon, film, sheet or the like, and the melt exhibits controlled, predictable flow properties.

In U.S. Pat. No. 3,144,436 the peroxide compounds are referred to as free radical initiators and they are employed in extruders to modify the melt index of the product.

In U.S. Pat. No. 3,887,534 aliphatic peroxides are employed to modify the intrinsic viscosity and melt flow rate of a crystalline polypropylene powder.

In U.S. Pat. No. 3,940,379 the controlled oxidative degradation of polypropylene is achieved through the use of certain peroxides. This patent emphasizes the essentially color and odor-free characteristics of the product obtained through minimal thermal degradation together with maximum oxidative degradation.

### SUMMARY OF THE INVENTION

In one embodiment the invention is a process for making a CR-polypropylene resin, the process comprising the step of contacting under scission conditions a non-CR-polypropylene resin having a low melt flow rate (MFR) with cyclic peroxide of formula I:

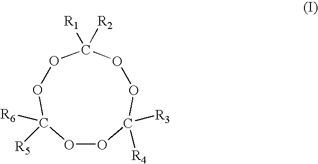

in which each R₁-R₆ is independently hydrogen or an inertly-substituted or unsubstituted C₁-C₂₀ alkyl, C₃-C₂₀ cycloalkyl, C₆-C₂₀ aryl, C₇-C₂₀ aralkyl or C₇-C₂₀ alkaryl. Representative of the inert-substituents included in R₁-R₆ are hydroxyl, C₁-C₁₀ alkoxy, linear or branched C₁-C₂₀ alkyl, C₆-C₂₀ aryloxy, halogen, ester, carboxyl, nitrile, and amido. Preferably, R₁-R₆ are each independently hydrogen or a lower alkyl i.e., C₁-C₁₀ alkyl, more preferably C₁-C₄ alkyl and even more preferably methyl or ethyl.

The CR-polypropylene resins made by the process of this invention, and the articles made from these resins, exhibit reduced VOC emissions relative to CR-polypropylene resins (and the articles made from these resins) made by an identical process except that a non-cyclic peroxide, e.g., LUPERSOL 101, is substituted for the cyclic peroxide of formula (I). These low-VOC CR-polypropylene resins are particularly useful in the manufacture of various low-VOC articles, particularly articles used as components in various automotive applications, e.g., automotive interiors and other enclosed areas.

### DETAILED DESCRIPTION OF THE INVENTION

Unless stated to the contrary, implicit from the context, or customary in the art, all parts and percents are based on weight and all test methods are current as of the filing date of this disclosure. For purposes of United States patent practice, the contents of any referenced patent, patent application or publication are incorporated by reference in their entirety (or its equivalent US version is so incorporated by reference) especially with respect to the disclosure of synthetic techniques, definitions (to the extent not inconsistent with any definitions specifically provided in this disclosure), and general knowledge in the art.

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, melt flow rate (MFR), etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, MFR, molecular weight, and various temperatures and other process ranges.

“Polymer” means a compound prepared by reacting (i.e., polymerizing) monomers, whether of the same or a different type. The generic term polymer thus embraces the term “homopolymer”, usually employed to refer to polymers prepared from only one type of monomer, and the term “interpolymer” as defined below.

“Interpolymer” and “copolymer” mean a polymer prepared by the polymerization of at least two different types of monomers. These generic terms include both classical copolymers, i.e., polymers prepared from two different types of monomers, and polymers prepared from more than two different types of monomers, e.g., terpolymers, tetrapolymers, etc.

“Propylene polymer”, “polypropylene” and like terms mean a polymer containing units derived from propylene. Propylene polymers typically comprise at least 50 mole percent (mol %) units derived from propylene.

“Polypropylene impact copolymer” and like terms mean a heterophasic propylene polymer typically having a high impact strength relative to a homopolymer of similar MFR. Polypropylene impact copolymers comprise a continuous phase of a propylene-based polymer, e.g., a propylene homopolymer or a propylene random copolymer, and a discontinuous phase of a rubber or similar elastomer, typically a propylene/ethylene copolymer.

“Low-MFR, non-CR-polypropylene resin” and like terms mean a non-CR-polypropylene resin that has an MFR of less than 10, typically less than 8 and more typically less than 5, grams per 10 minutes (g/10 min) as measured by ASTM D-1238-04, Procedure B, condition 230° C./2.16 kg.

“Non-CR-polypropylene resin” and like terms mean a polypropylene resin that has not been subjected to scission conditions.

“Scission conditions” and like terms mean conditions under which the MFR of a low-MFR, non-CR-polypropylene resin is increased by a factor of at least 2, preferably at least 3 and more preferably at least 4. Typical extrusion scission conditions are dependent on the thermal stability of the peroxide. For example, since TRIGONOX 301 is more thermally stable than LUPERSOL 101, a higher melt temperature is required for essentially complete peroxide decomposition (the typical melt temperature at the die exit of an extruder in which TRIGONOX 301 is used is about 250° C., for LUPERSOL 101 it is about 225° C.). EP 1 244 717 B1 provides an illustrative example of typical extrusion scission conditions.

“Inertly-substituted”, “inert substituent” and like terms mean a substituent on a compound or radical that is essentially non-reactive with the starting materials, catalyst and products of the process under process conditions. In the context of this invention, “inertly-substituted” and like terms mean that the substituent, be it on the polypropylene resin or the cyclic peroxide of formula I, does not interfere in the production of the CR-polypropylene resin under scission conditions.

### Propylene Polymer

The propylene polymer used in this invention may be a homopolymer, an interpolymer or random copolymer (i.e., two or more comonomers but having one phase), or an impact copolymer (i.e., a two-phase system in which the continuous phase is either a propylene homopolymer or a propylene random copolymer and the discontinuous or dispersed phase is typically a random propylene-ethylene copolymer of sufficiently high ethylene content to have rubbery characteristics. If a copolymer, it may be random (having either an isotactic or syndiotactic configuration of the units derived from propylene), and it is typically comprises at least 50, preferably at least 60, more preferably at least 70, even more preferably at least 80 and still more preferably at least 90, mole percent units derived from propylene. Polymer blends in which at least one of the blended polymers is polypropylene are included within scope of this invention. Preferably, such blends contain at least 50, preferably at least 60 and more preferably at least 70, weight percent (wt %) polypropylene.

The propylene polymer used in the practice of this invention may be a propylene impact copolymer. These impact copolymers are well known in the art, and are described generally in U.S. Pat. No. 5,258,464. Preferred propylene impact copolymers for use in this invention comprise a polypropylene matrix or continuous phase in combination with a rubber dispersed or discontinuous phase. The rubber content can vary widely, but it is typically from 10 to 30 percent by weight. The matrix phase is preferably a propylene homopolymer, but it can be a propylene copolymer. If the latter, the copolymer typically comprises up to 10 wt % comonomer, such as but not limited to, C₂ and C₄-C₁₂ alpha-olefins, e.g., ethylene, 1-butene, 1-hexene, 1-octene and the like.

The molecular weight of the non-CR-polypropylene used in the practice of this invention is conveniently indicated using a melt flow rate measurement according to ASTM D-1238 (230° C./2.16 kg). Melt flow rate (MFR) is inversely proportional to the molecular weight of the polymer. Thus, the higher the molecular weight, the lower the MFR, although the relationship is not linear. The MFR for the non-CR-polypropylene used in the practice of this invention is typically from 0.5 to 15, more typically from 1 to 10 and even more typically from 1 to 5, g/10 min. The MFR for the CR-polypropylene made by the process of this invention is typically from 2 to 100, more typically from 3 to 60 and even more typically from 5 to 30, g/10 min.

### Cyclic Peroxide

The cyclic peroxides used in the practice of this invention are of the formula:

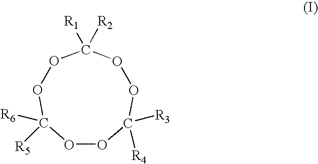

in which each R₁-R₆ is independently hydrogen or an inertly-substituted or unsubstituted C₁-C₂₀ alkyl, C₃-C₂₀ cycloalkyl, C₆-C₂₀ aryl, C₇-C₂₀ aralkyl or C₇-C₂₀ alkaryl. Representative of the inert-substituents included in R₁-R₆ are hydroxyl, C₁-C₂₀ alkoxy, linear or branched C₁-C₂₀ alkyl, C₆-C₂₀ aryloxy, halogen, ester, carboxyl, nitrile, and amido. Preferably, R₁-R₆ are each independently lower alkyl i.e., C₁-C₁₀ alkyl, more preferably C₁-C₄ alkyl.

Some of the cyclic peroxides of formula I are commercially available, but otherwise can be made by contacting a ketone with hydrogen peroxide as described in U.S. Pat. No. 3,003,000; Uhlmann, 3rd Ed., Vol. 13, pp. 256-57 (1962); the article, “Studies in Organic Peroxides XXV Preparation, Separation and Identification of Peroxides Derived from Methyl Ethyl Ketone and Hydrogen Peroxide,” Milas, N. A. and Golubovic, A., J. Am. Chem. Soc., Vol. 81, pp. 5824-26 (1959); “Organic Peroxides”, Swern, D. editor, Wiley-Interscience, New York (1970); and Houben-Weyl Methoden der Organische Chemie, E13, Volume 1, page 736.

Examples of the cyclic peroxides of formula I include the cyclic ketone peroxides derived from acetone, methylamyl ketone, methylheptyl ketone, methylhexyl ketone, methylpropyl ketone, methylbutyl ketone, diethyl ketone, methylethyl ketone methyloctyl ketone, methylnonyl ketone, methyldecyl ketone and methylundecyl ketone. The cyclic peroxides can be used alone or in combination with one another.

One preferred cyclic peroxide for use in this invention is 3,6,9-triethyl-3-6-9-trimethyl-1,4,7-triperoxonane commercially available from Akzo Nobel under the trade designation TRIGONOX 301.

The cyclic peroxide used in this invention can be liquid, solid or paste depending on the melting point of the peroxide and the diluent, if any, within which it is carried. Liquid formulations typically comprise a liquid phlegmatizer, a liquid plasticizer and the peroxide. Certain phlegmatizers, i.e., additives or agents which stabilize or desensitize the peroxide to early activation, may not be suitable for use with all of the peroxides useful in the practice of this invention. More particularly, in order to obtain a safe composition, the phlegmatizer should have a certain minimum flash point and boiling point relative to the decomposition temperature of the peroxide such that the phlegmatizer cannot be removed, e.g., boiled off, leaving a concentrated, unsafe peroxide composition behind. Thus, the lower boiling phlegmatizers mentioned below may only be useful, for example, with particular substituted ketone peroxides of the present invention which have a low decomposition temperature.

Examples of useful liquid phlegmatizers for use with the cyclic peroxides of formula I include various solvents, diluents and oils. More particularly, useful liquid phlegmatizers include alkanols, cyclo-alkanols, alkylene glycols, alkylene glycol monoalkyl ethers, cyclic ether substituted alcohols, cyclic amides, aldehydes, ketones, epoxides, esters, hydrocarbon solvents, halogenated hydrocarbon solvents, paraffinic oils, white oils and silicone oils.

### Process Protocol

The cyclic peroxide of formula I is typically added to low-MFR, non-CR-polypropylene pellets, powder, flake, etc. in a concentration of 50 to 10,000, more typically of 100 to 3,000 and even more typically of 300 to 3,000, parts per million (ppm) based on the weight of the polypropylene resin. The components (i.e., low-MFR, non-CR-polypropylene, peroxide and any optional additives) are typically premixed at temperatures ranging from 0 to 120° C., and then melt-compounded in an extruder or similar device at a temperature not exceeding 320° C., preferably not exceeding 290° C. Alternatively, the polypropylene and additives can be premixed at room temperature or at a higher temperature that still retains good powder flow properties and fed concurrently with the cyclic peroxide to an extruder. The mixture should be processed at a temperature of 175° C. to 290° C. which is above the melting point of the polypropylene and below its degradation temperature. Preferably all blending, mixing and compounding is conducted under an inert atmosphere, e.g., nitrogen.

The optional additives include, but are not limited to: ignition resistant additives, heat stabilizers, UV-stabilizers, colorants, antioxidants, antistatic agents, flow enhancers, mold releases, acid scavengers such as metal stearates (e.g., calcium stearate, magnesium stearate), nucleating agents, tracers and hydrocarbon solvents, e.g., hydrogenated oligomers of alkanes such as the Isopar® products commercially available from Exxon Mobile Corporation. If used, such additives may be present in an amount from at least 0.001, preferably at least 0.05 and more preferably at least 0.1, percent by weight based on the weight of the polypropylene. Generally, the additive is present in an amount less than or equal to 3, preferably less than or equal to 2 and more preferably less than or equal to 1, percent by weight based on the weight of the polypropylene.

The low-MFR, non-CR-polypropylene may be visbroken to achieve a specific MFR. However, preferably the visbreaking ratio (i.e., MFR after visbreaking to MFR before visbreaking) is limited to 50 or less, preferably to 40 or less and more preferably to 30 or less.

The process of this invention comprises contacting a cyclic peroxide of formula I with a low-MFR, non-CR-polypropylene to produce a reduced VOC-emitting, CR-polypropylene resin. These reduced VOC-emitting, CR-polypropylenes are particularly well suited for the production of reduced VOC-emitting articles such as various components used in the manufacture of non-metallic automotive parts, particularly parts used in the interior of automobiles. Indeed, these reduced VOC-emitting, CR-polypropylene resins are particularly well suited for manufacturing any articles that benefit from reduced VOC emissions. Articles produced from the reduced VOC-emitting CR-polypropylene typically emit at least 20, more typically at least 30 and even more typically at least 40, percent less VOC than like articles produced from CR-polypropylene made using peroxide other than cyclic peroxide of formula (I), the VOC emissions measured by the industry-accepted test method described in the examples below. “VOC-emitting” includes within its meaning the related concept of “C-emitting” or “carbon emitting” regardless of specific volatility.

The invention is described more fully through the following examples. Unless otherwise noted, all parts and percentages are by weight.

### EXAMPLES

### VOC Measurement Protocol

This protocol is used to determine the emission of organic compounds from non-metallic materials that directly or indirectly affect vehicle passenger compartments. Testing is carried out in accordance with VAG (Volkswagen Action Gesellshaft) Method PV 3341 with minor modifications. The emission potential is measured by gas chromatography analysis and flame ionization detection on the basis of the sum of all values provided by the emitted substances. Sample introduction is by headspace analysis after conditioning at 120° C. The modifications to PV3341 are given below and are referenced to the corresponding PP3411 sections.

The specimen is in the form of extruded pellets or granules used as received without conditioning. The amount of the sample used in the analysis is 2.000±0.001 gram. The specimen parts are weighed in 20 ml head space vials. The vial is sealed gas tight using a Teflon-coated septum.

The test procedure uses a Gas Chromatograph (GC) with capillary columns with a headspace sampling valve and FID detector. The capillary column is Varian CP-Sil 8 CB (5% dimethyl polysiloxane), 25 μm, 0.32 mm ID, 0.52 μm film thickness. The GC oven temperature program is as follows:
Initial temperature: 50° C.
Maximum temperature: 240° C.
Initial time: 0.00 minutes
Equilibration time: 0.50 minute
Heating to 240° C. with a rate of 10° C./minute
6 minutes isothermal at 240° C.
Injector temperature: 200° C.
Detector temperature: 250° C.
Carrier gas: helium
Mean carrier gas velocity: 35 cm/s

Prior to measurement the vials are conditioned in the air above the sample for 5 hours ±5 minutes at about 120° C. in the head space sample valve in order to enrich the vial with the substances contained in the sample. Immediately afterwards the vials are analyzed. One or two standards are used to test the proper function of the instrument.

Calibration is done with acetone standards. Acetone serves as a calibration substance for total carbon emission. For calibration, 100 μL, 150 μL and 200 μL of acetone is taken with a 250 μL Hamilton syringe. The acetone solution is weighted accurately with an analytical balance (0.1 mg) into a 50 ml volumetric flask and diluted with n-butanol to serve as a standard solution. 4.0 μL of each standard solution is sprayed into a 20 ml GC vial with three replicates. A calibration is built by plotting the peak area versus mg of carbon by linear fitting. Calibration is performed at least two times per year. If the mass recovery of standard solution is off by 5% or more a new calibration is performed.

2.000±0.001 gram samples are used in the analysis. The total VOC C-emission of the samples is calculated from the peak area by using the acetone calibration curve.

### Sample Preparation

SHAC 330 catalyst system available from The Dow Chemical Company is used in the preparation of the impact copolymers of these examples. The system comprises TiCl₄/MgCl₂ in combination with an external stereo-control agent (dicyclopentyldimethoxy silane or DCPDMS) and an activator (triethylaluminum).

Four impact copolymers are prepared in a UNIPOL pilot plant gas phase reator under standard gas phase polymerization conditions. The polymerizations are carried out in two sequential reactors. Homopolymerization of propylene is conducted in the first reactor. Hydrogen is used to obtain the desired MFR value. The catalyst system components are added at a rate to obtain the desired rate of polymerization. DCPDMS is added at a rate to obtain a nominal 1.5% xylene solubles.

The homopolymer powder containing active catalyst residues is intermittently transferred to a depressurization vessel to remove unreacted propylene monomer and other gaseous components. The depressurization vessel is pressurized with nitrogen to convey the homopolymer powder into the second reactor for polymerization with ethylene to make the ethylene-propylene rubber (EPR). Ethylene and propylene monomers are added in a ratio to obtain the desired EPR composition. Hydrogen is also used to obtain the desired MFR value. Impact copolymer powder is intermittently removed from the second reactor for subsequent compounding once the target compositions are obtained and the reactor system is lined out.

The impact copolymer composition is measured by a Fourier Transformation Infrared (FTIR) procedure which measures the total amount of ethylene in the impact copolymer (Et in wt %) and the amount of ethylene in the rubber fraction (Ec in wt %). The method is used for impact copolymers that have pure propylene homopolymer as the first reactor component and pure EPR as the second reactor component. The amount of rubber fraction (Fc in wt %) follows from the relationship

Et=Ec*Fc/100

Equivalent values of Et, Ec and Fc can be obtained by combining the amount of rubber fraction with the total ethylene content. As is well known in the art, the amount of rubber can be obtained from a mass balance of the reactors or from measurement of the titanium or magnesium residues from the first and second reactor products employing well known analytical methods. The total ethylene content of the impact copolymer can be measured by a variety of methods which include
1. FTIR by ASTM D 5576-00;
2. ¹³C NMR by S. Di Martino and M. Kelchtermans, “Determination of the Composition of Ethylene-Propylene Rubbers Using ¹³C NMR Spectroscopy”, Journal of Applied Polymer Science, Vol. 56, 1781-1787 (1995);
3. J. C. Randall, “A Review of High Resolution Liquid ¹³C NMR Characterizations of Ethylene-Based Polymers”, Journal of Macromolecular Science—Reviews of Macromolecular Chemical Physics, Ch. 29, 201-317 (1989); and
4. The methods detailed in United States Published Patent Application 2004/0215404.

Table 1 reports the impact copolymer compositions employed in these examples.

TABLE 1
Impact Copolymer Compositions

| Example | A | B | C | D |
|---|---|---|---|---|
| 1^{st} Reactor MFR | 4.5 | 2.4 | 13 | 13 |
| 2^{nd} Reactor MFR | 1.1 | 0.96 | 3.3 | 3.6 |
| Et (wt %) | 14.8 | 14.5 | 15.6 | 15 |
| Ec (wt % | 41.2 | 41.1 | 42.3 | 42.2 |
| Fc (wt %) | 36 | 35 | 37 | 36 |

The four impact copolymer compositions of Table 1 are stabilized with 1,000 parts per million (ppm) IRGANOX 1010 (tetrakis-(methylene-(3,5-di-(tert)-butyl-4-hydrocinnamate))-methane available from Ciba Specialty Chemicals Corporation), 1,000 PPM IRGAFOS PEP-Q (tetrakis(2,4-di-tert-butylphenyl)[1,1-biphenyl]-4,4′ diylbisphosphonite also available from Ciba Specialty Chemicals Corporation), and 250 ppm DHT-4A (hydrotalcite available from Kyowa Chemical). Some of the examples and comparative examples were nucleated with either NA-11 (methylene bis-(4,6-di-tert-butylphenyl)phosphate sodium salt) available from Amfine Chemical Corporation) or sodium benzoate. Details of sample nucleation are reported in Table 3. The samples are compounded without added peroxide and with various concentrations of LUPERSOL 101 and TRIGONOX 301. For the vis-broken samples, the peroxide is diluted with acetone and applied to the reactor powder with a syringe to obtain a relatively broad distribution of peroxide.

Following peroxide application, the reactor powder is placed in a polyethylene bag and shaken to obtain a uniform distribution of peroxide in the powder. Compounding is in a 30 millimeter (mm) Werner & Pfleiderer co-rotating twin screw extruder having a length to diameter (L/D) ratio of 24 to 1. Table 2 reports the extruder conditions for compounding with and without peroxide. Higher extruder temperature settings are used for TRIGONOX 301 to account for its higher decomposition temperature relative to LUPERSOL 101.

TABLE 2
Extrusion/Compounding Conditions

| Heater Band | Compounding | Compounding | Compounding |
|---|---|---|---|
| Set Points | w/o Vis-Breaking | w/L-101* | w/T-301** |
| Zone 1 | 180 | 180 | 185 |
| (° C.) | | | |
| Zone 2 | 185 | 185 | 190 |
| (° C.) | | | |
| Zone 3 | 190 | 190 | 200 |
| (° C.) | | | |
| Zone 4 | 190 | 190 | 220 |
| (° C.) | | | |
| Zone 5 | 195 | 195 | 230 |
| (° C.) | | | |
| Zone 6 | 195 | 195 | 230 |
| (° C.) | | | |
| Backpressure¹ | 360-510 | 200-280 | 220-300 |
| (psi) | | | |
| Screw Speed | 400 | 400 | 400 |
| (rpm) | | | |
| Melt Temp² | 220-251 | 217-240 | 249-252 |
| (° C.) | | | |

*L-101 is LUPERSOL 101
**T-301 is TRIGONOX 301
¹Backpressure is inversely related to melt flow rate.
²Melt temperature is measured at die exit with pyrometer.

TABLE 3
C-Emissions of Visbroken Polypropylene Impact Copolymers

| | Pre- | Post- | | | | | | |
|---|---|---|---|---|---|---|---|---|
| | Visbroken | Visbroken | Visbreak | | | | | Total Carbon |
| EX. | MFR^{1,2} | MFR¹ | Ratio | Peroxide | ppm | Nucleation | ppm | Emissions (Eg) |
| A-1 | 1.24 | 1.2 | 1 | none | | none | | 21 |
| A-2 | 1.25 | 1.3 | 1 | none | | NA-11 | 1000 | 19 |
| A-3 | 1.24 | 1.2 | 1 | none | | NaBZ | 750 | 18 |
| A-4 | 1.24 | 22.1 | 17.8 | L-101 | 950 | none | | 128 |
| A-5 | 1.25 | 20.6 | 16.5 | L-101 | 950 | NA-11 | 1000 | 129 |
| A-6 | 1.24 | 24.5 | 19.8 | L-101 | 950 | NaBz | 750 | 131 |
| A-7 | 1.24 | 18.1 | 14.6 | T-301 | 825 | NA-11 | 1000 | 53 |
| B-1 | 1.17 | 1.2 | 1 | none | | none | | 18 |
| B-2 | 1.12 | 1.1 | 1 | none | | NA-11 | 1000 | 18 |
| B-3 | 1.22 | 1.2 | 1 | none | | NaBZ | 750 | 20 |
| B-4 | 1.17 | 22.2 | 19.0 | L-101 | 950 | None | | 117 |
| B-5 | 1.12 | 18.0 | 16.1 | L-101 | 950 | NA-11 | 1000 | 115 |
| B-6 | 1.22 | 20.1 | 16.5 | L-101 | 950 | NaBZ | 750 | 100 |
| B-7 | 1.22 | 22.3 | 18.3 | T-301 | 825 | NA-11 | 1000 | 40 |
| C-1 | 3.52 | 3.5 | 1 | none | | none | | 23 |
| C-2 | 3.64 | 3.6 | 1 | none | | NA-11 | 1000 | 23 |
| C-3 | 4.02 | 4.0 | 1 | none | | NaBZ | 750 | 24 |
| C-4 | 3.52 | 19.8 | 5.6 | L-101 | 450 | none | | 82 |
| C-5 | 3.64 | 18.1 | 5.0 | L-101 | 450 | NA-11 | 1000 | 78 |
| C-6 | 4.02 | 22.5 | 5.6 | L-101 | 450 | NaBZ | 750 | 74 |
| C-7 | 4.02 | 20.7 | 5.1 | T-301 | 410 | NA-11 | 1000 | 40 |
| D-1 | 3.6 | 3.6 | 1 | none | | none | | 27 |
| D-2 | 3.7 | 3.7 | 1 | none | | NA-11 | 1000 | 28 |
| D-3 | 4.0 | 4.0 | 1 | none | | NaBZ | 750 | 26 |
| D-4 | 3.6 | 18.3 | 5.0 | T-101 | 450 | none | | 84 |
| D-5 | 3.7 | 19.8 | 5.3 | T-101 | 450 | NA-11 | 1000 | 91 |
| D-6 | 4.0 | 20.5 | 5.2 | T-101 | 450 | NaBZ | 750 | 82 |
| D-7 | 4.0 | 20.1 | 5.0 | T-301 | 410 | NA-11 | 1000 | 45 |

¹MFR is determined according to the procedure of ASTM D-1238-04, Procedure B, Condition 230° C./2.16 kg.
²The average slightly higher MFR value for the pre-visbroken samples compared to the second reactor MFR's in Table 1 due to melt flow break associated with the compounding/extrusion of the samples.

As can be seen from the results in Table 2, the Total Carbon emission Eg (i.e., VOC) obtained using T-301, i.e. TRIGONOX 301, are about one-half of the Eg Total Carbon for the same polypropylene visbroken with T-101, i.e., TRIGONOX 101. This result is completely surprising and unexpected. Optional antioxidants, acid scavengers and conventional nucleating agents can be used with the polypropylene base polymers.

Although the invention has been described with certain detail through the preceding specific embodiments, this detail is for the primary purpose of illustration. Many variations and modifications can be made by one skilled in the art without departing from the spirit and scope of the invention as described in the following claims.

What is claimed is:

1. A process for making a controlled rheology (CR) polypropylene resin, the process comprising the step of contacting under scission conditions a non-CR-polypropylene resin having a low melt flow rate (MFR) with cyclic peroxide of the formula: 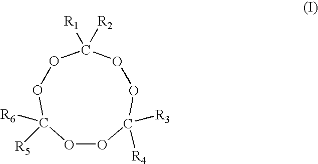
in which each R₁-R₆ is independently hydrogen or an inertly-substituted or unsubstituted C₁-C₂₀ alkyl, C₃-C₂₀ cycloalkyl, C₆-C₂₀ aryl, C₇-C₂₀ aralkyl or C₇-C₂₀ alkaryl.

2. The process of claim 1 in which one or more of R₁-R₆ is inertly substituted with one or more of hydroxyl, C₁-C₂₀ alkoxy, linear or branched C₁-C₂₀ alkyl, C₆-C₂₀ aryloxy, halogen, ester, carboxyl, nitrile and amido.

3. The process of claim 1 in which R₁-R₆ are each independently C₁-C₁₀ alkyl.

4. The process of claim 1 in which the cyclic peroxide is present in an amount of 50 to 10,000 ppm.

5. The process of claim 1 in which the cyclic peroxide is present in an amount of 100 to 3,000 ppm.

6. The process of claim 1 in which the scission conditions include a temperature of 175 to 290° C.

7. The process of claim 1 in which the non-CR-polypropylene resin is at least one of a propylene homopolymer, propylene random copolymer, or a propylene impact copolymer.

8. The process of claim 1 in which the non-CR-polypropylene resin has an MFR of less than 10 g/10 min as measured by ASTM D-1238-04, Procedure B, condition 230° C./2.16 kg.

9. The process of claim 1 in which the cyclic peroxide is 3,6,9-triethyl-3,6,9-trimethyl-1,4,7-triperoxonane.

10. A CR-polypropylene resin made by the process of claim 1.

11. An article comprising the CR-polypropylene resin of claim 10.

12. The article of claim 11 in the shape of a component for the interior of an automobile.

13. The article of claim 11 from which VOC emissions are at least 20 percent less that the VOC emissions of a like article produced from CR-polypropylene made in the same manner as the CR-polypropylene of claim 1 except that the peroxide was non-cyclic.

14. The article of claim 11 from which VOC emissions are at least 30 percent less that the VOC emissions of a like article produced from CR-polypropylene made in the same manner as the CR-polypropylene of claim 1 except that the peroxide was non-cyclic.
